(19) United States
(12) Patent Application Publication
(10) Pub. No.: US 2016/0239903 A1
(43) Pub. Date: Aug. 18, 2016

(54) SYSTEM AND METHOD FOR EFFICIENT ORDER FULFILLMENT USING REAL-TIME LOCATION DATA

(71) Applicant: CloudCar, Inc., Mountain View, CA (US)

(72) Inventor: Konstantin Othmer, Los Altos, CA (US)

(21) Appl. No.: 15/042,099

(22) Filed: Feb. 11, 2016

Related U.S. Application Data
(60) Provisional application No. 62/115,406, filed on Feb. 12, 2015.

(51) Int. Cl. G06Q 30/06; H04L 12/58; H04L 29/08

(52) U.S. Cl. CPC G06Q 30/0635; H04L 67/18; H04L 51/20

(57) ABSTRACT

A system and method for efficient order fulfillment using real-time location data are disclosed. A particular embodiment includes: obtaining information related to a transaction initiated by a user with a vendor, the transaction requiring the user's presence at a vendor location; obtaining information indicative of a location of the user; determining, by execution of a data processor, a predicted arrival time at which the user is expected to arrive at the vendor location, the predicted arrival time being based in part on the user location and the vendor location; and posting an electronic message at a network location accessible to the vendor, the electronic message including information indicative of the predicted arrival time.

### PRIORITY PATENT APPLICATION

This is a non-provisional patent application drawing priority from co-pending U.S. provisional patent application Ser. No. 62/115,406; filed Feb. 12, 2015. This present non-provisional patent application draws priority from the referenced provisional patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2012-2016, CloudCar Inc., All Rights Reserved.

### TECHNICAL FIELD

This patent document pertains generally to tools (systems, apparatuses, methodologies, computer program products, etc.) for allowing electronic devices to share information with each other, and more particularly, but not by way of limitation, to a system and method for efficient order fillfillment using real-time location data.

### BACKGROUND

Many automated systems exist to facilitate online order delivery (e.g., items delivered to a user via Amazon®). Standard systems also exist for online ordering with user pick-up at a vendor's location (e.g., merchants, retailers, restaurants, etc.). Also commonplace is online booking and reservations (e.g., hotels, restaurants, event locations, etc.) where the user can book travel or attendance reservations for a specific destination. In a traditional online ordering with user pick-up scenario, an order is placed with a vendor by the user who proceeds to pick up the order at the vendor location based on a fixed, estimated, or pre-arranged processing and pick-up time. However, none of the systems today are able to automatically modify the order or the pick-up time in real time by taking user location and travel time into account.

### BRIEF DESCRIPTION OF THE DRAWINGS

The various embodiments are illustrated by way of example, and not by way of limitation, in the figures of the accompanying drawings in which:

FIG. 1 illustrates a block diagram of an example ecosystem in which an in-vehicle order fulfillment processing module of an example embodiment can be implemented;

FIG. 2 illustrates the components of the in-vehicle order fulfillment processing module of an example embodiment;

FIG. 3 illustrates example embodiments in which the processing of various embodiments is implemented by applications (apps) executing on any of a variety of platforms;

FIG. 4 is a process flow diagram illustrating an example embodiment of a system and method for efficient order fulfillment using real-time location data; and

FIG. 5 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

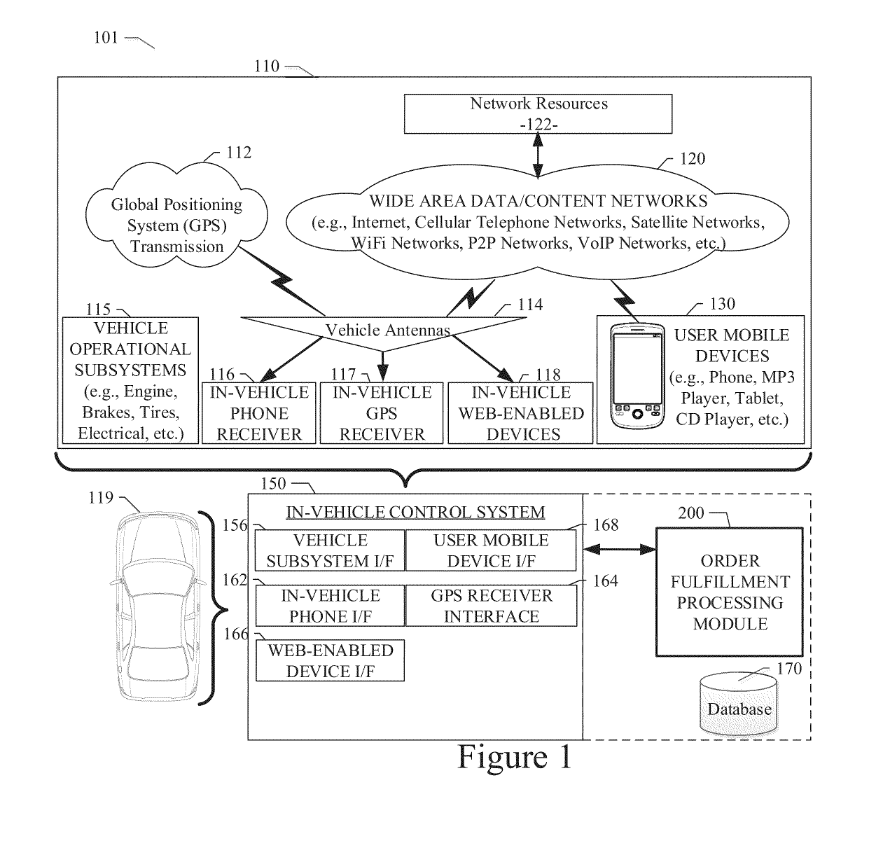

As described in various example embodiments, a system and method for efficient order fulfillment using real-time location data are described herein. The various embodiments disclosed herein are relevant to the case of a user physically traveling to a vendor location, as opposed to a vendor shipping an item to the user. The various embodiments allow the transaction to become more efficient, thereby increasing convenience, and reducing potential delays for the user by introducing predictive, location-based processing. In one example embodiment, an in-vehicle control system with an order fulfillment processing module resident in a vehicle can be configured like the architecture illustrated in FIG. 1. However, it will be apparent to those of ordinary skill in the art that the order fulfillment processing module described and claimed herein can be implemented, configured, and used in a variety of other applications and systems as well.

In an example embodiment, an online order or transaction for goods or services can be placed with a vendor by a customer/user, possibly through an interactive advertisement. The customer/user initiating the transaction intends to travel to a vendor location to obtain the ordered item or service. The online order can be conveyed from the user to the vendor using a process similar to traditional methods, such as online ordering or order submittal by telephone. In the example embodiment, the real-time location of the user can be determined via the user's mobile device or the in-vehicle control system of the user's vehicle. Given the user's permission, the real-time location of the user can be continually or periodically updated in a network cloud service and/or in applications (apps) running on user devices (e.g., the user mobile device and/or the user's in-vehicle control system). The real-time location of the user can be made available to the vendor via the cloud service or the user device apps. The cloud service or the user device apps can execute a computer-implemented process to predict the arrival time of the user at the vendor location. The predicted arrival time can be determined using the user's current location, speed, direction, route selection or historical route patterns of the user, current traffic, current weather, geo-fencing, etc. Geo-fencing uses a dynamically generated or pre-defined boundary around a geographical point location or area. When a location-aware device transitions the geo-fence boundary, the device transmits or receives an automatically-generated notification. This notification might contain information about the current location of the device. The notification might trigger the device, a device app, or the cloud service to perform a processing action, such as computing the speed, direction, and/or predicted arrival time of the user at the vendor location. The predicted arrival time of the user can be continually or periodically updated in the cloud service or in the user device apps and made available to the vendor. The vendor can receive updates of the user's real-time location and predicted arrival time from the cloud service or the user device apps and can modify the processing of the user's order to best meet the user's estimated arrival time. Upon arrival at the vendor location, the user can receive the order (e.g., by being met by a vendor representative at the user's vehicle) with a perfectly timed and ready order.

In an alternative embodiment, a dynamic scheduling model enables a customer/user to automatically extend or modify a reservation or appointment based on the user's predicted arrival time as computed by the cloud service or the user device apps. For example, a customer who has scheduled an appointment with a service provider (e.g., doctor, dentist, lawyer, accountant, etc.) or a reservation at a restaurant or other venue can get the appointment/reservation time automatically adjusted based on the user's predicted arrival time computed by the cloud service or the user device apps. A predicted arrival time that falls outside of a pre-configured threshold can trigger a notification to vendor and/or the customer.

In another alternative embodiment, the customer/user can be offered location-based or time-based electronic coupons or other purchase incentives that create incentives for customers travelling from particular locations within a particular time frame to be able to receive goods/services discounts from particular vendors. Coupons can be targeted for particular customers, because the customer's profile is known or can be obtained from the customer's mobile device, the customer's in-vehicle control system, and/or the network cloud service. Coupon values can be configured for particular customers, particular locations, and/or particular time frames. For example, historical data can be used to reward a customer for a habit of arriving on time at the vendor location for order pick-ups. Historical data can also be used to reward a customer for frequently ordering from or visiting a particular vendor location. Additionally, a referral incentive can be set up to reward a customer for referring another customer from or to a given vendor location. A coupon can also reward the customer for using the in-vehicle control system, the cloud service, and/or a related mobile device application (app).

In an example embodiment as described herein, a mobile device app in combination with the cloud service can be used to implement the order fulfillment process as described herein. In the example embodiment, a Global Positioning System (GPS) data receiver, accelerometers, WiFi triangulation, or other geographical location (geo-location) sensors or components in the mobile device can be used to determine the real-time geo-location of the user (via the mobile device) at any moment in time. The cloud service or the mobile device app can be used to compute the user's predicted arrival time at the vendor location based on the user's current location, speed, direction, route selection or historical route patterns, geo-fencing, current traffic, current weather, etc. In a second example embodiment, an in-vehicle control system resident in a user's vehicle and the cloud service can be used to implement the order fulfillment process as described herein. In the second example embodiment, a GPS data receiver, accelerometers, WiFi triangulation, or other geo-location sensors or components in the in-vehicle control system can be used to determine the real-time geo-location of the user and the user's vehicle at any moment in time. The cloud service or the in-vehicle control system (or an app running in the in-vehicle control system) can be used to compute the user's predicted arrival time at the vendor location based on the user's current location, speed, direction, route selection or historical route patterns, geo-fencing, current traffic, current weather, etc.

Referring now to FIG. 1, a block diagram illustrates an example ecosystem 101 in which an in-vehicle control system 150 and an order fulfillment processing module 200 of an example embodiment can be implemented. These components are described in more detail below. Ecosystem 101 includes a variety of systems and components that can generate and/or deliver one or more sources of information/data and related services to the in-vehicle control system 150 and the order fulfillment processing module 200, which can be installed in a vehicle 119. For example, a standard Global Positioning System (GPS) network 112 can generate geo-location data and timing data or other navigation information that can be received by an in-vehicle GPS receiver 117 via vehicle antenna 114. The in-vehicle control system 150 and the order fulfillment processing module 200 can receive this geo-location data, timing data, and navigation information via the GPS receiver interface 164, which can be used to connect the in-vehicle control system 150 with the in-vehicle GPS receiver 117 to obtain the geo-location data, timing data, and navigation information.

Similarly, ecosystem 101 can include a wide area data/content network 120. The network 120 represents one or more conventional wide area data/content networks, such as the Internet, a cellular telephone network, satellite network, pager network, a wireless broadcast network, gaming network, WiFi network, peer-to-peer network, Voice over IP (VoIP) network, etc. One or more of these networks 120 can be used to connect a user or client system with network resources 122, such as websites, servers, call distribution sites, headend content delivery sites, or the like. The network resources 122 can generate and/or distribute data, which can be received in vehicle 119 via one or more antennas 114. The network resources 122 can also host network cloud services, which can support the functionality used to compute the user's predicted arrival time at the vendor location based on the user's current location, speed, direction, route selection or historical route patterns, geo-fencing, current traffic, current weather, etc. Antennas 114 can serve to connect the in-vehicle control system 150 and the order fulfillment processing module 200 with the data/content network 120 via cellular, satellite, radio, or other conventional signal reception mechanisms. Such cellular data or content networks are currently available (e.g., Verizon™, AT&T™, T-Mobil™, etc.). Such satellite-based data or content networks are also currently available (e.g., SiriusXM™, HughesNet™, etc.). The conventional broadcast networks, such as AM/FM radio networks, pager networks, UHF networks, gaming networks, WiFi networks, peer-to-peer networks, Voice over IP (VoIP) networks, and the like are also well-known. Thus, as described in more detail below, the in-vehicle control system 150 and the order fulfillment processing module 200 can receive telephone calls and/or phone-based data transmissions via an in-vehicle phone interface 162, which can be used to connect with the in-vehicle phone receiver 116 and network 120. The in-vehicle control system 150 and the order fulfillment processing module 200 can also receive web-based data or content via an in-vehicle web-enabled device interface 166, which can be used to connect with the in-vehicle web-enabled device receiver 118 and network 120. In this manner, the in-vehicle control system 150 and the order fulfillment processing module 200 can support a variety of network-connectable in-vehicle devices and systems from within a vehicle 119.

As shown in FIG. 1, the in-vehicle control system 150 and the order fulfillment processing module 200 can also receive data and content from user mobile devices 130, which are located inside or proximately to the vehicle 119. The user mobile devices 130 can represent standard mobile devices, such as cellular phones, smartphones, personal digital assistants (PDA's), MP3 players, tablet computing devices (e.g., iPad™), laptop computers, CD players, and other mobile devices, which can produce and/or deliver data and content for the in-vehicle control system 150 and the order fulfillment processing module 200. As shown in FIG. 1, the mobile devices 130 can also be in data communication with the network cloud 120. The mobile devices 130 can source data and content from internal memory components of the mobile devices 130 themselves or from network resources 122 via network 120. Additionally, mobile devices 130 can themselves include a GPS data receiver, accelerometers, WiFi triangulation, or other geo-location sensors or components in the mobile device, which can be used to determine the real-time geo-location of the user (via the mobile device) at any moment in time. In each case, the in-vehicle control system 150 and the order fulfillment processing module 200 can receive this data and content from the user mobile devices 130 as shown in FIG. 1.

In various embodiments, the mobile device 130 interface and user interface between the in-vehicle control system 150 and the mobile devices 130 can be implemented in a variety of ways. For example, in one embodiment, the mobile device 130 interface between the in-vehicle control system 150 and the mobile devices 130 can be implemented using a Universal Serial Bus (USB) interface and associated connector. In another embodiment, the interface between the in-vehicle control system 150 and the mobile devices 130 can be implemented using a wireless protocol, such as WiFi or Bluetooth™ (BT). WiFi is a popular wireless technology allowing an electronic device to exchange data wirelessly over a computer network. Bluetooth™ is a wireless technology standard for exchanging data over short distances. Using standard mobile device 130 interfaces, a mobile device 130 can be paired and/or synchronized with the in-vehicle control system 150 when the mobile device 130 is moved within a proximity region of the in-vehicle control system 150. The user mobile device interface 168 can be used to facilitate this pairing. Once the in-vehicle control system 150 is paired with the mobile device 130, the mobile device 130 can share information with the in-vehicle control system 150 and the order fulfillment processing module 200 in data communication therewith.

Referring again to FIG. 1 in an example embodiment as described above, the in-vehicle control system 150 and the order fulfillment processing module 200 can receive geo-location data, navigation data, traffic information, weather information, road condition information, road construction schedules, vendor information, and/or other types of data and content from a variety of sources in ecosystem 101, both local (e.g., within proximity of the in-vehicle control system 150) and remote (e.g., accessible via data network 120). These sources can include wireless broadcasts, data and content from proximate user mobile devices 130 (e.g., a mobile device proximately located in or near the vehicle 119), data and content from network 120 cloud-based resources 122, an in-vehicle phone receiver 116, an in-vehicle GPS receiver or navigation system 117, in-vehicle web-enabled devices 118, or other in-vehicle devices that produce or distribute data and/or content.

Referring still to FIG. 1, the example embodiment of ecosystem 101 can include vehicle operational subsystems 115. For embodiments that are implemented in a vehicle 119, many standard vehicles include operational subsystems, such as electronic control units (ECUs), supporting monitoring/control subsystems for the engine, brakes, transmission, electrical system, emissions system, interior environment, and the like. For example, data signals communicated from the vehicle operational subsystems 115 (e.g., ECUs of the vehicle 119) to the in-vehicle control system 150 via vehicle subsystem interface 156 may include information about the state of one or more of the components or subsystems of the vehicle 119. In particular, the data signals, which can be communicated from the vehicle operational subsystems 115 to a Controller Area Network (CAN) bus of the vehicle 119, can be received and processed by the in-vehicle control system 150 and the order fulfillment processing module 200 via vehicle subsystem interface 156. Embodiments of the systems and methods described herein can be used with substantially any mechanized system that uses a CAN bus or similar data communications bus as defined herein, including, but not limited to, industrial equipment, boats, trucks, machinery, or automobiles; thus, the term “vehicle” as used herein can include any such mechanized systems. Embodiments of the systems and methods described herein can also be used with any systems employing some form of network data communications; however, such network communications are not required.

In the example embodiment shown in FIG. 1, the in-vehicle control system 150 can also include a rendering system to enable a user to view and/or hear information, content, and control prompts provided by the in-vehicle control system 150. The rendering system can include standard visual display devices (e.g., plasma displays, liquid crystal displays (LCDs), touchscreen displays, heads-up displays, or the like) and speakers or other audio output devices.

Additionally, other data and/or content (denoted herein as ancillary data) can be obtained from local and/or remote sources by the in-vehicle control system 150 as described above. The ancillary data can be used to augment or modify the operation of the order fulfillment processing module 200 based on a variety of factors including, user context (e.g., the identity, age, profile, and driving history of the user), the context in which the user is operating the vehicle (e.g., the location of the vehicle, the specified destination, direction of travel, speed, the time of day, the status of the vehicle, etc.), and a variety of other data obtainable from a variety of sources, local and remote.

In a particular embodiment, the in-vehicle control system 150 and the order fulfillment processing module 200 can be implemented as in-vehicle components of vehicle 119. In various example embodiments, the in-vehicle control system 150 and the order fulfillment processing module 200 in data communication therewith can be implemented as integrated components or as separate components. In an example embodiment, the software components of the in-vehicle control system 150 and/or the order fulfillment processing module 200 can be dynamically upgraded, modified, and/or augmented by use of the data connection with the mobile devices 130 and/or the network resources 122 via network 120. The in-vehicle control system 150 can periodically query a mobile device 130 or a network resource 122 for updates or updates can be pushed to the in-vehicle control system 150.

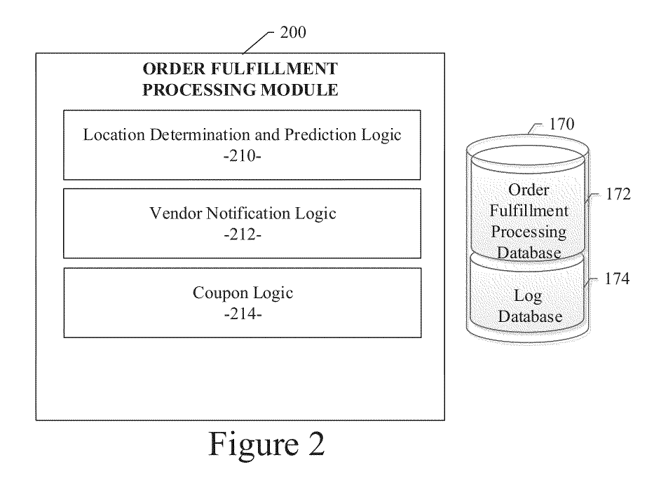

Referring now to FIG. 2, the diagram illustrates the components of the order fulfillment processing module 200 of an example embodiment. In the example embodiment, the order fulfillment processing module 200 can be configured to include an interface with the in-vehicle control system 150, as shown in FIG. 1, through which the order fulfillment processing module 200 can send and receive data as described above. Additionally, the order fulfillment processing module 200 can be configured to include an interface with the in-vehicle control system 150 and/or other ecosystem 101 subsystems through which the order fulfillment processing module 200 can receive ancillary data from the various data and content sources as described above.

In an example embodiment as shown in FIG. 2, the order fulfillment processing module 200 can be configured to include a location determination and prediction logic module 210, a vendor notification logic module 212, and a coupon logic module 214. Each of these modules can be implemented as software, firmware, or other logic components executing or activated within an executable environment of the order fulfillment processing module 200 operating within or in data communication with the in-vehicle control system 150. Each of these modules of an example embodiment is described in more detail below in connection with the figures provided herein.

The location determination and prediction logic module 210 of an example embodiment is responsible for determining the real-time location of the user based on the location reported by the user's mobile device and/or the user's in-vehicle control system. As described above, the real-time geo-location of the user can be determined using a GPS data receiver, accelerometers, WiFi triangulation, or other geo-location sensors, components, or processes in the user's mobile device and/or the user's in-vehicle control system. This geo-location data can be used by the location determination and prediction logic module 210 to compute the user's predicted arrival time at a vendor location based on the user's current location, speed, direction, route selection or historical route patterns, geo-fencing, current traffic, current weather, etc. The particular vendor location can be obtained by the location determination and prediction logic module 210 from a destination entered into the user's mobile device or a destination entered into a navigation sub-system of the user's in-vehicle control system. The user's current and historical route selections can be obtained from the user's mobile device or the vehicle navigation system in combination with data stored in order fulfillment processing database 172, which may be stored in the user's mobile device, in the user's in-vehicle control system, and/or in the network 120 cloud. Other navigation data, traffic information, weather information, road condition information, road construction schedules, vendor information, and/or other types of data and content can be obtained from a variety of sources in ecosystem 101, both local (e.g., within proximity of the in-vehicle control system 150) and remote (e.g., accessible via data network 120). The location determination and prediction logic module 210 can use this data to compute the user's predicted arrival time at the vendor location. This predicted arrival time can be stored in the user's mobile device, in the user's in-vehicle control system, and/or in the network 120 cloud. The predicted arrival time and other user data can be stored with a user identifier. The user identifier can be generated using a user login or account identifier, a unique user device identifier (e.g., a MAC address, a telephone number, etc.), an Internet Protocol (IP) address associated with the user, or other known techniques or combinations thereof for uniquely identifying a user and/or a user vehicle. The predicted arrival time, user identifier, and other user information can also be made available to the vendor notification logic module 212 and the coupon logic module 214 described in more detail below.

In an example embodiment as shown in FIG. 2, the order fulfillment processing module 200 can be configured to include the vendor notification logic module 212. The vendor notification logic module 212 of an example embodiment is responsible for facilitating communications with vendors or vendor locations from which a particular user has ordered goods or services or scheduled appointments or reservations. Additionally, the vendor notification logic module 212 of an example embodiment can be responsible for notifying pre-configured and approved third parties of a transaction with a particular vendor. For example, the vendor notification logic module 212 can be configured to send an electronic message (e.g., an email, an SMS text message, a tweet, a datagram, or other data transmission) to one or more pre-determined recipients, such as a particular vendor or vendor location, a vendor agent, a vendor aggregator service, a payment service, an electronic coupon service, or any other third party recipient. The vendor notification logic module 212 can also be configured to post an electronic message at a pre-defined location in the network 120 cloud. The electronic message can be configured to be explicitly sent or posted in response to a user command or automatically sent or posted when the mobile device 130 or the vehicle 119 cross a geo-fence boundary, when the mobile device 130 or the vehicle 119 are within a pre-defined number of miles or minutes from the vendor location, when the mobile device 130 or the vehicle 119 pass a waypoint on a route to the vendor location, or when one or more other events occur. The automatically transmitted or posted electronic message can also be triggered by a variety of other pre-determined events or conditions, including vehicle operation inside or outside of a specified geographical region or timeframe, vehicle operation on or off of a route to the vendor location, detection of a vehicle subsystem fault, or a variety of other events or conditions. The automatically transmitted or posted electronic message can include data or information indicative of the identity or identifier of the particular user or vehicle, the identity or identifier of the particular vendor from which goods or services were ordered, the location of the particular user or vehicle, the predicted time at which the particular user or vehicle will arrive at the vendor location, the current status of the user or vehicle, the event(s) or condition(s) that triggered the electronic message, and any other information that would assist the vendor provide efficient and timely service for the user. The automatically transmitted or posted electronic message can also include data or information associated with payment for the order. For example, a payment authorization or receipt can be sent to the vendor via the vendor notification logic module 212.

The vendor notification logic module 212 of an example embodiment can also be configured to receive electronic messages back from the vendor or various third parties directly or via the network cloud service. The electronic messages can be retrieved from a pre-defined location in the network 120 cloud. For example, a vendor or third party can return an acknowledgement when the vendor or third party receives an automatically transmitted electronic message from the vendor notification logic module 212. A vendor or third party can also return information related to the ordered goods or services. For example, the vendor can notify the user via the vendor notification logic module 212 that delivery of the goods or services may be delayed. The vendor can also request the user via the vendor notification logic module 212 that the order or pick-up time needs clarification. Moreover, as described in more detail below, the vendor can send a coupon, discount voucher, advertisement, order receipt, payment receipt, or other information or documents to the user in real-time via the vendor notification logic module 212.

In an example embodiment shown in FIG. 2, the order fulfillment processing module 200 can include a coupon logic module 214. The coupon logic module 214 of an example embodiment is responsible for managing electronic coupons or other purchase incentives offered by one or more vendors. The coupon logic module 214 can be configured to automatically scan particular websites or perform automatic web searches for electronic coupons or purchase incentives offered by one or more vendors. The coupon logic module 214 can retain found coupons or incentives (or pointers thereto) that are likely to be of use to a particular user. For example, coupons or incentives that are likely to be of use to a particular user can include coupons or incentives that relate to vendors with whom the user has transacted previously, vendors that provide or relate to goods or service categories the user has previously used or searched, vendor locations that are proximate to the user's location, vendor locations that are located on routes frequently traveled by the user, and a variety of other user-related or vendor-related criteria. The found coupons or incentives (or pointers thereto) can be retained in database 170. Additionally, coupons or incentives received from particular vendors via the vendor notification logic module 212 can also be saved in database 170.

When a user places an order or otherwise initiates a transaction for goods or services with a particular vendor or the in-vehicle control system 150 determines that the user or vehicle is in route to a particular vendor location, the coupon logic module 214 can search the coupon or purchase incentive data in database 170 for coupons or incentives that match the vendor with whom the user is currently transacting. If a matching coupon or purchase incentive is found, the coupon logic module 214 can automatically apply the coupon or purchase incentive to the transaction by sending information related to the coupon or purchase incentive to the vendor (or the related cloud service) via the vendor notification logic module 212. In this manner, the coupon logic module 214 can manage coupons or purchase incentives for the user/driver and can automatically apply the coupons or purchase incentives when they are applicable.

An example embodiment can record or log parameters associated with the order fulfillment performed by the order fulfillment processing module 200. For example, the described embodiments can record or log parameters associated with user accounts, user payment data, transactions or orders placed by particular users, transactions placed with particular vendors, vendor locations, user or vehicle routes taken to particular vendor locations, timing associated with user or vehicle routings, vendor ratings, electronic coupons or other purchase incentives offered by one or more vendors, and a variety of other information associated with order fulfillment. These log parameters can be stored in log database 174 of database 170 as shown in FIG. 2. The log parameters can be used as a historical reference to retain information related to the manner in which a particular vendor transaction was processed for a particular user. This historical data can be used in the subsequent processing of a similar transaction with the same vendor for the user.

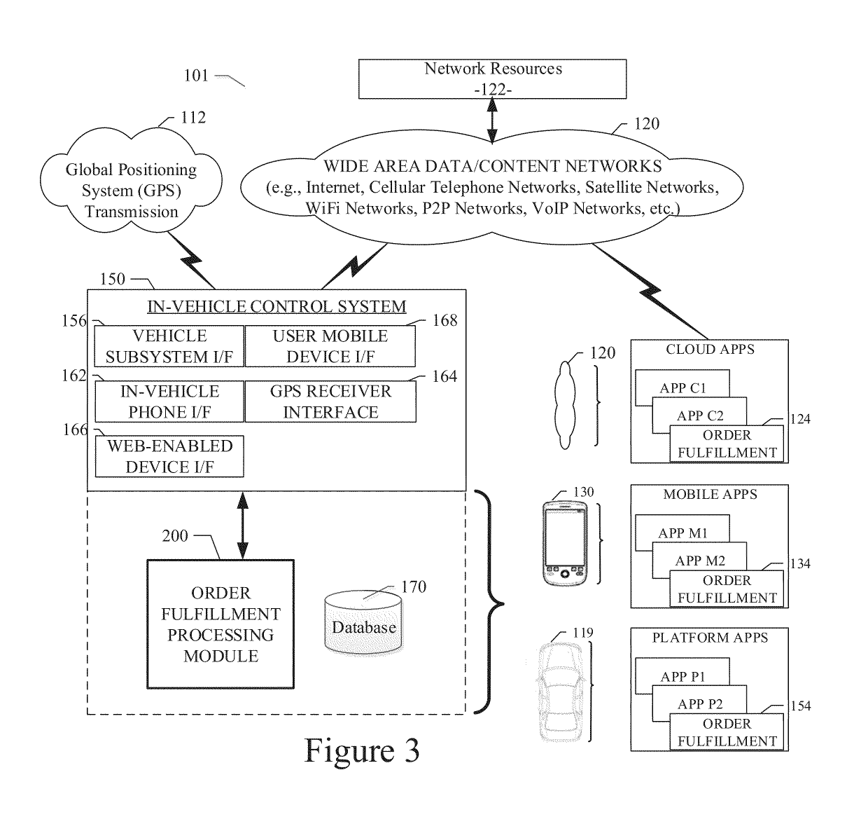

Referring now to FIG. 3, example embodiments are illustrated in which the processing of various embodiments is implemented by applications (apps) executing on any of a variety of platforms. As shown in FIG. 3, the processing performed by the order fulfillment processing module 200 can be implemented in whole or in part by an app 154 executing on the in-vehicle control system 150 of vehicle 119, an app 134 executing on the mobile device 130, and/or an app 124 executing at a network resource 122 by a network service in the network cloud 120. The app 154 running on the in-vehicle control system 150 of vehicle 119 can be executed by a data processor of the in-vehicle control system 150. The results of this processing can be provided directly to subsystems of the in-vehicle control system 150. The app 134 running on the mobile device 130 can be executed by a data processor of the mobile device 130. The process for installing and executing an app on a mobile device 130 is well-known to those of ordinary skill in the art. The results of this processing can be provided to the mobile device 130 itself and/or the in-vehicle control system 150 via the mobile device interface. The app 124 running at a network resource 122 by a network service in the network cloud 120 can be executed by a data processor at the network resource 122. The process for installing and executing an app at a network resource 122 is also well-known to those of ordinary skill in the art. The results of this processing can be provided to the mobile device 130 and/or the in-vehicle control system 150 via the network 120 and the mobile device interface. As a result, the order fulfillment processing module 200 can be implemented in any of a variety of ways using the resources available in the ecosystem 101.

Thus, as described herein in various example embodiments, the order fulfillment processing module 200 can facilitate a transaction between a particular user/driver and a particular vendor from which the user/driver has ordered goods or services. As a result, the various embodiments allow the transaction to become more efficient, thereby increasing convenience, and reducing potential delays for the user by introducing predictive, location-based processing.

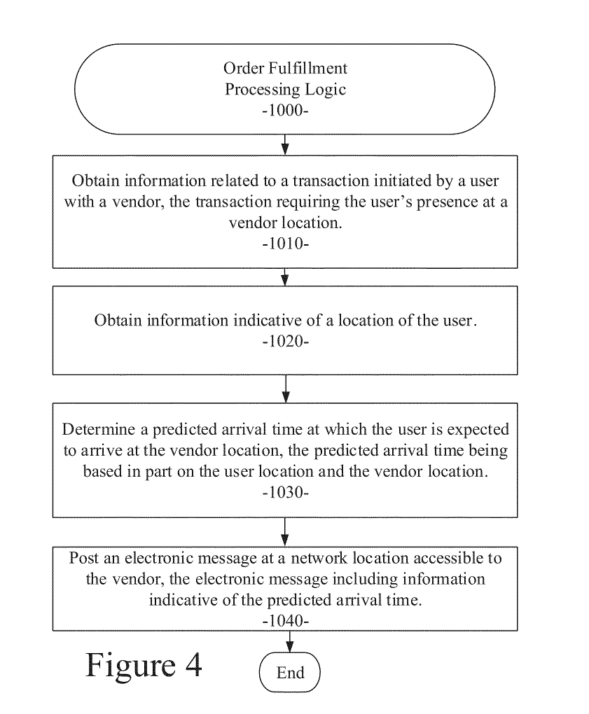

Referring now to FIG. 4, a flow diagram illustrates an example embodiment of a system and method 1000 for efficient order fulfillment using real-time location data. The example embodiment includes: obtaining information related to a transaction initiated by a user with a vendor, the transaction requiring the user's presence at a vendor location (processing block 1010); obtaining information indicative of a location of the user (processing block 1020); determining a predicted arrival time at which the user is expected to arrive at the vendor location, the predicted arrival time being based in part on the user location and the vendor location (processing block 1030); and posting an electronic message at a network location accessible to the vendor, the electronic message including information indicative of the predicted arrival time (processing block 1040).

As used herein and unless specified otherwise, the term “mobile device” includes any computing or communications device that can communicate with the in-vehicle control system 150 and/or the order fulfillment processing module 200 described herein to obtain read or write access to data signals, messages, or content communicated via any mode of data communications. In many cases, the mobile device 130 is a handheld, portable device, such as a smart phone, mobile phone, cellular telephone, tablet computer, laptop computer, display pager, radio frequency (RF) device, infrared (IR) device, global positioning device (GPS), Personal Digital Assistants (PDA), handheld computers, wearable computer, portable game console, other mobile communication and/or computing device, or an integrated device combining one or more of the preceding devices, and the like. Additionally, the mobile device 130 can be a computing device, personal computer (PC), multiprocessor system, microprocessor-based or programmable consumer electronic device, network PC, diagnostics equipment, a system operated by a vehicle 119 manufacturer or service technician, and the like, and is not limited to portable devices. The mobile device 130 can receive and process data in any of a variety of data formats. The data format may include or be configured to operate with any programming format, protocol, or language including, but not limited to, JavaScript™, C++, iOS, Android™, etc.

As used herein and unless specified otherwise, the term “network resource” includes any device, system, or service that can communicate with the in-vehicle control system 150 and/or the order fulfillment processing module 200 described herein to obtain read or write access to data signals, messages, or content communicated via any mode of inter-process or networked data communications. In many cases, the network resource 122 is a data network accessible computing platform, including client or server computers, websites, mobile devices, peer-to-peer (P2P) network nodes, and the like. Additionally, the network resource 122 can be a web appliance, a network router, switch, bridge, gateway, diagnostics equipment, a system operated by a vehicle 119 manufacturer or service technician, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein. The network resources 122 may include any of a variety of providers or processors of network transportable digital content. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3-MP3, and the like), video (e.g., MP4, and the like), and any proprietary interchange format defined by specific content sites can be supported by the various embodiments described herein.

The wide area data network 120 (also denoted the network cloud) used with the network resources 122 can be configured to couple one computing or communication device with another computing or communication device. The network may be enabled to employ any form of computer readable data or media for communicating information from one electronic device to another. The network 120 can include the Internet in addition to other wide area networks (WANs), cellular telephone networks, metro-area networks, local area networks (LANs), other packet-switched networks, circuit-switched networks, direct data connections, such as through a universal serial bus (USB) or Ethernet port, other forms of computer-readable media, or any combination thereof. The network 120 can include the Internet in addition to other wide area networks (WANs), cellular telephone networks, satellite networks, over-the-air broadcast networks, AM/FM radio networks, pager networks, UHF networks, other broadcast networks, gaming networks, WiFi networks, peer-to-peer networks, Voice Over IP (VoIP) networks, metro-area networks, local area networks (LANs), other packet-switched networks, circuit-switched networks, direct data connections, such as through a universal serial bus (USB) or Ethernet port, other forms of computer-readable media, or any combination thereof. On an interconnected set of networks, including those based on differing architectures and protocols, a router or gateway can act as a link between networks, enabling messages to be sent between computing devices on different networks. Also, communication links within networks can typically include twisted wire pair cabling, USB, Firewire, Ethernet, or coaxial cable, while communication links between networks may utilize analog or digital telephone lines, full or fractional dedicated digital lines including T1, T2, T3, and T4, Integrated Services Digital Networks (ISDNs), Digital User Lines (DSLs), wireless links including satellite links, cellular telephone links, or other communication links known to those of ordinary skill in the art. Furthermore, remote computers and other related electronic devices can be remotely connected to the network via a modem and temporary telephone link.

The network 120 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network may also include an autonomous system of terminals, gateways, routers, and the like connected by wireless radio links or wireless transceivers. These connectors may be configured to move freely and randomly and organize themselves arbitrarily, such that the topology of the network may change rapidly. The network 120 may further employ one or more of a plurality of standard wireless and/or cellular protocols or access technologies including those set forth herein in connection with network interface 712 and network 714 described in the figures herewith.

In a particular embodiment, a mobile device 130 and/or a network resource 122 may act as a client device enabling a user to access and use the in-vehicle control system 150 and/or the order fulfillment processing module 200 to interact with one or more components of a vehicle subsystem. These client devices 130 or 122 may include virtually any computing device that is configured to send and receive information over a network, such as network 120 as described herein. Such client devices may include mobile devices, such as cellular telephones, smart phones, tablet computers, display pagers, radio frequency (RF) devices, infrared (IR) devices, global positioning devices (GPS), Personal Digital Assistants (PDAs), handheld computers, wearable computers, game consoles, integrated devices combining one or more of the preceding devices, and the like. The client devices may also include other computing devices, such as personal computers (PCs), multiprocessor systems, microprocessor-based or programmable consumer electronics, network PC's, and the like. As such, client devices may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a color LCD display screen in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

The client devices may also include at least one client application that is configured to receive content or messages from another computing device via a network transmission. The client application may include a capability to provide and receive textual content, graphical content, video content, audio content, alerts, messages, notifications, and the like. Moreover, the client devices may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. The client devices may also include a wireless application device on which a client application is configured to enable a user of the device to send and receive information to/from network resources wirelessly via the network.

The in-vehicle control system 150 and/or the order fulfillment processing module 200 can be implemented using systems that enhance the security of the execution environment, thereby improving security and reducing the possibility that the in-vehicle control system 150 and/or the order fulfillment processing module 200 and the related services could be compromised by viruses or malware. For example, the in-vehicle control system 150 and/or the order fulfillment processing module 200 can be implemented using a Trusted Execution Environment, which can ensure that sensitive data is stored, processed, and communicated in a secure way.

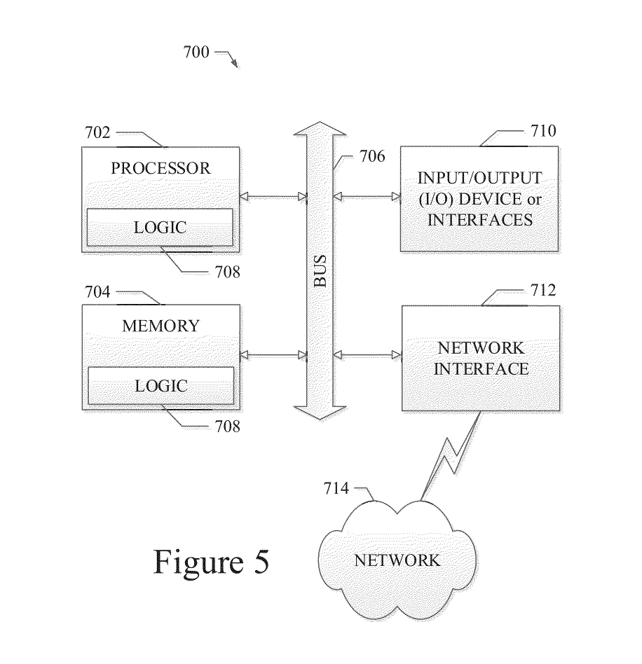

FIG. 5 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 can include a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, a voice interface, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication and data processing mechanisms by which information/data may travel between a mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a data processor; and
an order fulfillment processing module, executable by the data processor, the order fulfillment processing module being configured to:
obtain information related to a transaction initiated by a user with a vendor, the transaction requiring the user's presence at a vendor location;
obtain information indicative of a location of the user;
determine a predicted arrival time at which the user is expected to arrive at the vendor location, the predicted arrival time being based in part on the user location and the vendor location; and
post an electronic message at a network location accessible to the vendor, the electronic message including information indicative of the predicted arrival time.

2. The system as claimed in claim 1 wherein the order fulfillment processing module is included in an application (app) executed on a platform from the group consisting of: a mobile device, an in-vehicle control system, and a network service in a network cloud.

3. The system as claimed in claim 1 wherein the predicted arrival time is also based in part on the user's speed, direction, and route selection.

4. The system as claimed in claim 1 wherein the predicted arrival time is also based in part on the current traffic and current weather.

5. The system as claimed in claim 1 wherein the information indicative of the user location is obtained from a Global Positioning System (GPS) data receiver on a platform from the group consisting of: a mobile device and an in-vehicle control system.

6. The system as claimed in claim 1 being further configured to send an electronic message to the vendor.

7. The system as claimed in claim 1 being further configured to automatically send an electronic message to the vendor upon occurrence of an event from the group consisting of: the user crosses a geo-fence boundary or the user is within a pre-defined number of miles or minutes from the vendor location.

8. The system as claimed in claim 1 being further configured to notify pre-configured and approved third parties of the transaction with the vendor.

9. The system as claimed in claim 1 being further configured to obtain a coupon associated with the vendor.

10. A method comprising:
obtaining information related to a transaction initiated by a user with a vendor, the transaction requiring the user's presence at a vendor location;
obtaining information indicative of a location of the user;
determining, by execution of a data processor, a predicted arrival time at which the user is expected to arrive at the vendor location, the predicted arrival time being based in part on the user location and the vendor location; and
posting an electronic message at a network location accessible to the vendor, the electronic message including information indicative of the predicted arrival time.

11. The method as claimed in claim 10 wherein the method is performed by an application (app) executed on a platform from the group consisting of: a mobile device, an in-vehicle control system, and a network service in a network cloud.

12. The method as claimed in claim 10 wherein the predicted arrival time is also based in part on the user's speed, direction, and route selection.

13. The method as claimed in claim 10 wherein the predicted arrival time is also based in part on the current traffic and current weather.

14. The method as claimed in claim 10 wherein the information indicative of the user location is obtained from a Global Positioning System (GPS) data receiver on a platform from the group consisting of: a mobile device and an in-vehicle control system.

15. The method as claimed in claim 10 including sending an electronic message to the vendor.

16. The method as claimed in claim 10 including automatically sending an electronic message to the vendor upon occurrence of an event from the group consisting of: the user crosses a geo-fence boundary or the user is within a pre-defined number of miles or minutes from the vendor location.

17. The method as claimed in claim 10 including notifying pre-configured and approved third parties of the transaction with the vendor.

18. The method as claimed in claim 10 including obtaining a coupon associated with the vendor.

19. A non-transitory machine-useable storage medium embodying instructions which, when executed by a machine, cause the machine to:
obtain information related to a transaction initiated by a user with a vendor, the transaction requiring the user's presence at a vendor location;
obtain information indicative of a location of the user;
determine a predicted arrival time at which the user is expected to arrive at the vendor location, the predicted arrival time being based in part on the user location and the vendor location; and
post an electronic message at a network location accessible to the vendor, the electronic message including information indicative of the predicted arrival time.

20. The machine-useable storage medium as claimed in claim 19 wherein the instructions are included in an application (app) executed on a platform from the group consisting of: a mobile device, an in-vehicle control system, and a network service in a network cloud.
